(19) United States
(12) Patent Application Publication
(10) Pub. No.: US 2025/0085549 A1
(43) Pub. Date: Mar. 13, 2025

(54) APPARATUS, SYSTEMS, AND METHODS OF A COMPACT, HIGH NUMERICAL APERTURE LIGHT ENGINE

(71) Applicant: Applied Materials, Inc., Santa Clara, CA (US)

(72) Inventors: Kunal SHASTRI, Santa Clara, CA (US); Sheng YUAN, Santa Clara, CA (US); Paul GALLAGHER, Santa Clara, CA (US); Gauthier BRIERE, Hoofddorp (NL); Samarth BHARGAVA, Saratoga, CA (US); Robert Jan VISSER, Menlo Park, CA (US)

(21) Appl. No.: 18/811,937

(22) Filed: Aug. 22, 2024

Related U.S. Application Data
(60) Provisional application No. 63/582,212, filed on Sep. 12, 2023.

(51) Int. Cl. G02B 27/01; B82Y 20/00; G02B 27/10

(52) U.S. Cl. CPC G02B 27/0172; B82Y 20/00; G02B 27/1053; G02B 2027/0114; G02B 2027/014; G02B 2207/101

(57) ABSTRACT

Implementations of the present disclosure relate to apparatus, systems, and methods of a compact, high numerical aperture light engine, for example thin optics-based light engine systems using meta-surfaces for wearable displays. One implementation includes an optical device. The optical device includes one or more spatial light modulators, wherein each spatial light modulator is an array of pixels that are individually controllable to output visible light. The optical device also includes a surface defining an exit pupil that is arranged to allow the output visible light to exit the optical device via the exit pupil. The optical device also includes one or more metasurfaces disposed between the one or more spatial light modulators and the exit pupil. The one or more metasurfaces are to focus the visible light that is output by the one or more spatial light modulators.

### CROSS-REFERENCE TO RELATED APPLICATIONS

This Application claims the benefit of U.S. Provisional Patent Application Ser. No. 63/582,212 filed Sep. 12, 2023, which is hereby incorporated by reference

### BACKGROUND

### Field

Implementations of the present disclosure relate to apparatus, systems, and methods of a compact, high numerical aperture light engine, for example thin optics-based light engine systems using meta-surfaces for wearable displays.

### Description of the Related Art

Wearable displays, such as smart glasses or mixed reality headsets for augmented reality and virtual reality applications, are increasingly in use and popularity. Such wearable displays for augmented and virtual reality have risen in popularity due in part to their ability to provide immersive and interactive experiences. For example, augmented reality glasses overlay digital information on top of the real world, while virtual reality glasses create a fully immersive digital environment. These technologies have become increasingly accessible and affordable, with advancements in hardware and software enabling more realistic and convincing experiences. Wearable displays, such as augmented and virtual reality glasses, have found applications in various industries, including gaming, entertainment, education, and healthcare, among others.

Wearable displays may typically use spatial light modulators, which may also be referred to as light engines. For such wearable displays, a light engine having a compact form factor and a large numerical aperture (NA) for improved light collection efficiency may be desirable. However, current light engines may be bulky and complicated For example, current approaches may use four or even five lenses elements to achieve acceptable projection quality metrics such as a high modulation transfer function (MTF) for image quality and larger NA. Additionally, to achieve a uniform illumination across a field of view (FOV) of a spatial light modulator, a telecentric architecture may be necessary. The telecentric architecture may further increase the system footprint and complexity.

As these technologies continue to evolve and become more sophisticated, their popularity is expected to grow further and further improvements are desired, such as maintaining or improving display quality while further reducing weight and bulk of such wearable displays.

### SUMMARY

Implementations of the present disclosure relate to apparatus, systems, and methods of a compact, high numerical aperture light engine, for example thin optics-based light engine systems using meta-surfaces for wearable displays. One implementation includes an optical device. The optical device includes one or more spatial light modulators, wherein each spatial light modulator is an array of pixels that are individually controllable to output visible light. The optical device also includes a surface defining an exit pupil that is arranged to allow the output visible light to exit the optical device via the exit pupil. The optical device also includes one or more metasurfaces disposed between the one or more spatial light modulators and the exit pupil. The one or more metasurfaces are to focus the visible light that is output by the one or more spatial light modulators.

One or more implementations include a wearable display. The wearable display includes a wearable support, a first optical device, and a second optical device. The first optical device is retained by the wearable support and positioned to be viewed by a first eye of a user of the wearable display. The second optical device is retained by the wearable support and positioned to be viewed by a second eye of the user. In one or more implementations, each of the first optical device and the second optical device include one or more spatial light modulators, where each spatial light modulator has an array of pixels that are individually controllable to output visible light. In one or more implementations, each of the first optical device and the second optical device also include a surface defining an exit pupil that is arranged to allow the output visible light to exit the optical device via the exit pupil. In one or more implementations, each of the first optical device and the second optical device also has one or more metasurfaces disposed between the one or more spatial light modulators and the surface defining the exit pupil. The one or more metasurfaces are to focus the visible light that is output by the one or more spatial light modulators.

Another implementation includes a method of generating an optical image. In one or more implementations, method includes generating, from each spatial light modulator of one or more spatial light modulators of an optical device, visible light using an array of pixels that are individually controllable. In one or more implementations, the method also includes focusing the visible light that is output using one or more metasurfaces of the optical device. In one or more implementations, the method also includes directing the visible light to exit the optical device using a surface defining an exit pupil of the optical device. The exit pupil is arranged to allow the output visible light to exit the optical device via the exit pupil. The one or more metasurfaces are disposed between the one or more spatial light modulators and the exit pupil.

### BRIEF DESCRIPTION OF THE DRAWINGS

So that the manner in which the above-recited features of the disclosure can be understood in detail, a more particular description of the disclosure, briefly summarized above, may be had by reference to implementations, some of which are illustrated in the appended drawings. It is to be noted, however, that the appended drawings illustrate only common implementations of this disclosure and are therefore not to be considered limiting of its scope, for the disclosure may admit to other equally effective implementations.

FIG. 1 is a schematic, frontal view of glasses according to one or more implementations.

FIG. 2 is a schematic view of an optical device, according to one or more implementations.

FIG. 3 is a schematic view of an optical device, according to one or more implementations.

FIG. 4 is a schematic view of an optical device, according to one or more implementations.

FIG. 5 is a schematic view of an optical device, according to one or more implementations.

FIG. 6 is a flow diagram of a method for generating an optical image, according to one or more implementations.

To facilitate understanding, identical reference numerals have been used, where possible, to designate identical elements that are common to the figures. It is contemplated that elements disclosed in one or more implementations may be beneficially utilized on other implementations without specific recitation.

### DETAILED DESCRIPTION

Wearable displays, such as smart glasses or mixed reality headsets for augmented reality and virtual reality applications, may typically use spatial light modulators, which may also be referred to as light engines, as part of a wearable display. Ultra-compact form factor light engine that has a large numerical aperture (NA) for improved light collection efficiency may reduce the overall device form-factor and weight of the wearable display, as well as improve the power efficacy.

As further described herein, a thin, flat, optical device, including an optics-based light engine (spatial light modulator) system is disclosed. The light engine system can provide one or more (e.g., simultaneously) near diffraction limited image resolution (high modulation transfer function (MTF)), high NA, and telecentric uniform illumination, in a reduced sized form-factor (e.g., an ultra-compact form-factor). One or more implementations use meta-surfaces, such as one or more metalenses.

One implementation includes an optical device. The optical device includes one or more spatial light modulators, wherein each spatial light modulator is an array of pixels that are individually controllable to output visible light. The optical device also includes a surface defining an exit pupil that is arranged to allow the output visible light to exit the optical device via the exit pupil. The optical device also includes one or more metasurfaces disposed between the one or more spatial light modulators and the exit pupil. The one or more metasurfaces are to focus the visible light that is output by the one or more spatial light modulators.

One or more implementations include a wearable display. The wearable display includes a wearable support, a first optical device, and a second optical device. The first optical device is retained by the wearable support and positioned to be viewed by a first eye of a user of the wearable display. The second optical device is retained by the wearable support and positioned to be viewed by a second eye of the user. In one or more implementations, each of the first optical device and the second optical device include one or more spatial light modulators, where each spatial light modulator has an array of pixels that are individually controllable to output visible light. In one or more implementations, each of the first optical device and the second optical device also include a surface defining an exit pupil that is arranged to allow the output visible light to exit the optical device via the exit pupil. In one or more implementations, each of the first optical device and the second optical device also has one or more metasurfaces disposed between the one or more spatial light modulators and the surface defining the exit pupil. The one or more metasurfaces are to focus the visible light that is output by the one or more spatial light modulators.

Another implementation includes a method of generating an optical image. In one or more implementations, method includes generating, from each spatial light modulator of one or more spatial light modulators of an optical device, visible light using an array of pixels that are individually controllable. In one or more implementations, the method also includes focusing the visible light that is output using one or more metasurfaces of the optical device. In one or more implementations, the method also includes directing the visible light to exit the optical device using a surface defining an exit pupil of the optical device. The exit pupil is arranged to allow the output visible light to exit the optical device via the exit pupil. The one or more metasurfaces are disposed between the one or more spatial light modulators and the exit pupil.

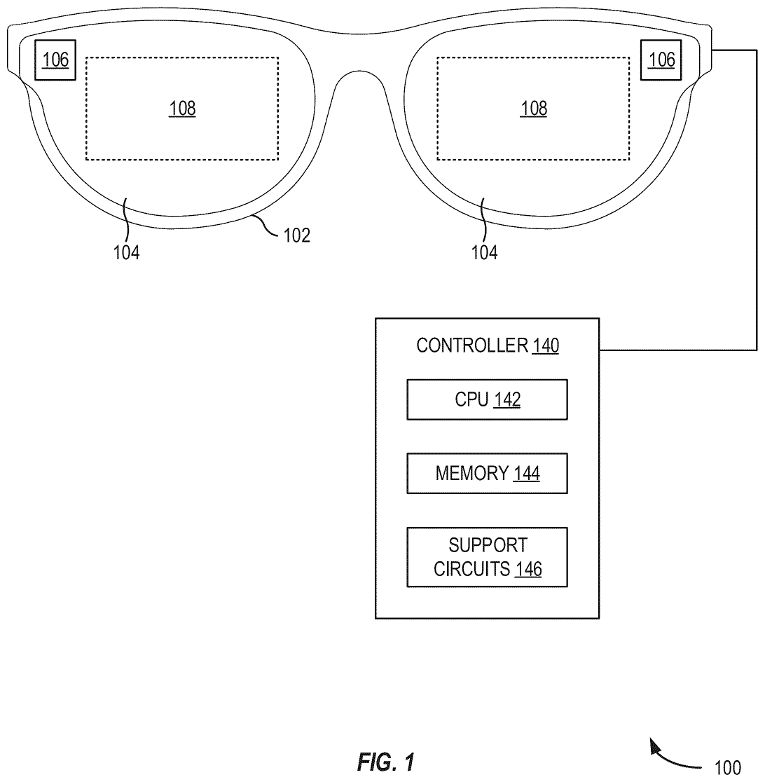

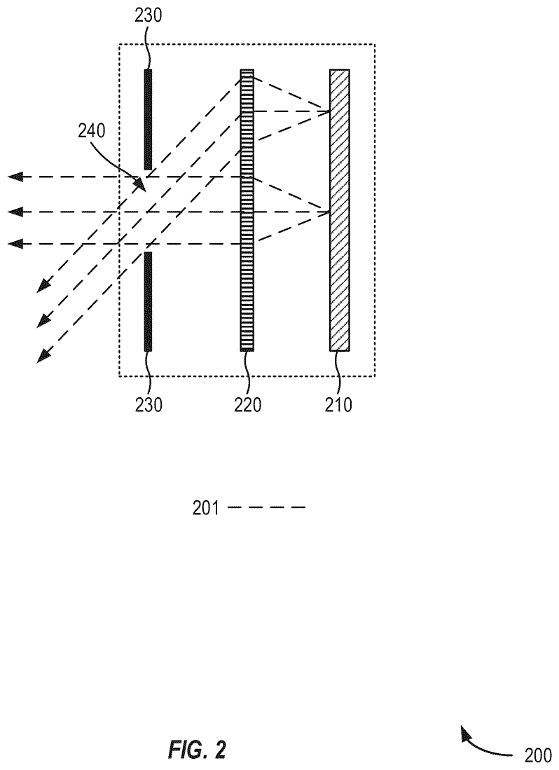

FIG. 1 is a schematic, frontal view of glasses 100 according to one or more implementations. In one or more embodiments, the glasses 100 are operable to be virtual reality (VR) or augmented reality (AR) glasses. The glasses 100 include a frame 102. The frame 102 retains a pair of optical device lenses 104. Each lens of the pair of optical device lenses 104 includes an image incoupler 106 and an image outcoupler 108. In one embodiment, which can be combined with other embodiments described herein, the image incoupler 106 and the image outcoupler 108 are arranged so as to achieve substantially total internal reflection of light between the image incoupler 106 and the image outcoupler 108. In another embodiment, which can be combined with other embodiments described herein, each lens of the pair of optical device lenses 104 includes one of an optical device 200, an optical device 300, an optical device 400, or an optical device 500 (shown in FIGS. 2 through 5, respectively). The optical devices of the optical device lenses 104 are physically coupled together such that the pair of optical device lenses 104 may be retained by the frame 102.

Although glasses 100 illustrate the pair of optical device lenses 104 retained by the frame 102, the pair of optical device lenses 104 are not limited to the frame 102. For example, other wearable supports to retain the pair of optical device lenses 104 in close proximity to a user's eyes (near-eye) may be utilized, such as with alternate frame shapes, other devices such as a head-mounted display (HMD), or other wearable display devices that have near-eye display panels as lenses, to display a virtual or augmented reality environment.

A system controller 140, such as a programmable computer, is coupled to the remainder of the glasses 100, or components thereof. For example, the system controller 140 may control the operation of one or more of optical device lenses 104 or using indirect control of other controllers associated therewith. In operation, the system controller 140 enables data acquisition and feedback to coordinate operation of optical device lenses 104.

The system controller 140 includes a programmable central processing unit (CPU) 142, which is operable with a memory 144 (e.g., non-volatile memory) and support circuits 146. The support circuits 146 (e.g., cache, clock circuits, input/output subsystems, power supplies, etc., and combinations thereof) are conventionally coupled to the CPU 142 and coupled to the various other components of the glasses 100.

In some embodiments, the CPU 142 is one of any form of general purpose computer processor, such as a programmable logic controller (PLC), for controlling various monitoring system component and sub-processors. The memory 144, coupled to the CPU 142, is non-transitory and is typically one or more of readily available memory such as random access memory (RAM), read only memory (ROM), floppy disk drive, hard disk, or any other form of digital storage, local or remote.

Herein, the memory 144 is in the form of a computer-readable storage media containing instructions (e.g., non-volatile memory), that when executed by the CPU 142, facilitates the operation of the glasses 100. The instructions in the memory 144 are in the form of a program product such as a program that implements the methods of the present disclosure (e.g., middleware application, equipment software application, etc.). The program code may conform to any one of a number of different programming languages. In one example, the disclosure may be implemented as a program product stored on computer-readable storage media for use with a computer system. The program(s) of the program product define functions of the embodiments (including the methods described herein).

Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the methods described herein, are embodiments of the present disclosure.

In one or more embodiments, one or more of CPU 142, memory 144, or support circuits of system controller 140 may be integrated into a single package, module, or integrated circuit (IC), together with or communicatively coupled with one or more components or subcomponents of optical device lenses 104, for example an optical device 200, an optical device 300, an optical device 400, or an optical device 500 (shown in FIGS. 2 through 5, respectively).

FIG. 2 is a schematic view of an optical device 200, according to one or more implementations. In one or more implementations, optical device 200 includes or is a component of an optical device lens 104. Optical device 200 includes a spatial light modulator 210, metasurface 220, and a surface 230 that defines an exit pupil 240. In one or more embodiments, optical device 200 is configured to operate on monochromatic light, for example a single wavelength or range of wavelengths of optical light 201, for example associated with one color of visible light.

In one or more embodiments, spatial light modulator 210 may be or be referred to as a light engine. In one or more implementations, spatial light modulator 210 is a light emitting diode (LED) light engine. An LED light engine is an integrated assembly composed of one or more LEDs or LED arrays (modules), as well as an LED driver and other optical, thermal, mechanical, and electrical components.

In one or more embodiments, metasurface 220 may be or be referred to as a metalens. In one example, a metalens is an emerging type of tiny flat optical element that use sub-wavelength nanostructure to diffract electromagnetic waves over the length of a few wavelengths. In one or more embodiments, metasurface 220, for example as a metalens can manipulate the amplitude, phase, and/or polarization of a light wave to achieve one or more of a large NA, near diffraction-limited image resolution, or a large FOV. In one or more embodiments, metasurface 220 is a nanopillar, nanofin, or Huygens disk type structure. Metasurface 220 is designed and configured to focus a particular wavelength, or range of wavelengths of optical light 201, toward the exit pupil 240 of the optical device 200.

In one or more embodiments, metasurface 220 is a nanopillar metalens. A nanopillar metalens is a type of optical lens that uses an array of metallic nanopillars to focus light. Unlike traditional lenses that use refraction to bend light, nanopillar metalenses use the principles of plasmonics and diffraction to manipulate light waves. In one or more embodiments, the nanopillar metalens is made up of metallic nanopillars, such as a thin layer of metal (e.g., gold, silver), that is patterned into an array of pillars, each pillar typically about a few hundred nanometers in size. These pillars are arranged according to a pattern to create a lens-like structure that can focus light for example from the spatial light modulator 210 toward the exit pupil 240.

In one or more embodiments, metasurface 220 is a nanopillar metalens having round nanopillars. A round nanopillar type metalens may work to focus both polarized and unpolarized light. Additionally, the round nanopillar type metalens may focus the optical light 201 with a relatively large bandwidth (e.g., wideband operation), including a center frequency and a range of frequencies including the center frequency.

In one or more embodiments, metasurface 220 is a nanopillar metalens having fin (rectangular) nanopillars. In one or more embodiments, a fin nanopillar has a rectangular pillar shape (length different than width, or a same length and width).

A fin nanopillar type metalens may work to focus both polarized and unpolarized light. Additionally, the round nanopillar type metalens may focus the optical light 201 with a relatively large bandwidth (e.g., wideband operation), including a center frequency and a range of frequencies including the center frequency. Additionally, for the fin nanopillar type metalens, the length and width of the nanopillars can be tuned to alter the phase of the optical light 201 that is being focused.

In one or more embodiments, metasurface 220 is a Huygens metalens. The metasurface of a Huygens metalens includes an array of subwavelength-scale elements, typically made of metal or dielectric material, that are arranged in a specific pattern. Each of these elements acts as a miniature Huygens' source that generates secondary wavelets that interfere with each other to shape the incoming light wave of the optical light 201. The size, shape, and spacing of these elements can be designed to control the phase and amplitude of the wavefront, effectively creating a lens-like effect that can focus, manipulate, or shape light the optical light 201 in a desired way, and direct the optical light 201 towards the exit pupil 240. In one or more embodiments, an advantage of the metasurface 220 being a Huygens metalens is that such design may operate well with optical light 201 being polarized light.

In one or more embodiments, metasurface 220 is another type of metasurface, for example having nano-structures configured or adapted to be capable of providing a relatively higher NA, high image sharpness focusing, or both.

In one or more embodiments, the surface 230 that defines the exit pupil 240 is a hard aperture, such as an opaque curved or flat planar surface having an aperture (pupil, stop or system stop, hole). In one or more embodiments, the exit pupil 240 is a projected aperture, for example as part of an incoupling grating, or for example as or as part of the image incoupler 106.

In some embodiments, the exit pupil 240 is round or substantially round. In some embodiments, the exit pupil 240 is rectangular or square, or substantially rectangular or square. In some embodiments, the exit pupil 240 has a different shape, for example designed or configured for a particular wearable device.

One or more advantages of one or more of the embodiments of optical device 200 include that optical device 200 may be combined into a single module or assembly, or used separately as single-color device, or micro-LED based light engines. Optical device 200 may provide for provide for lower cost, increased design simplicity, manufacturing flexibility, and smaller form factor.

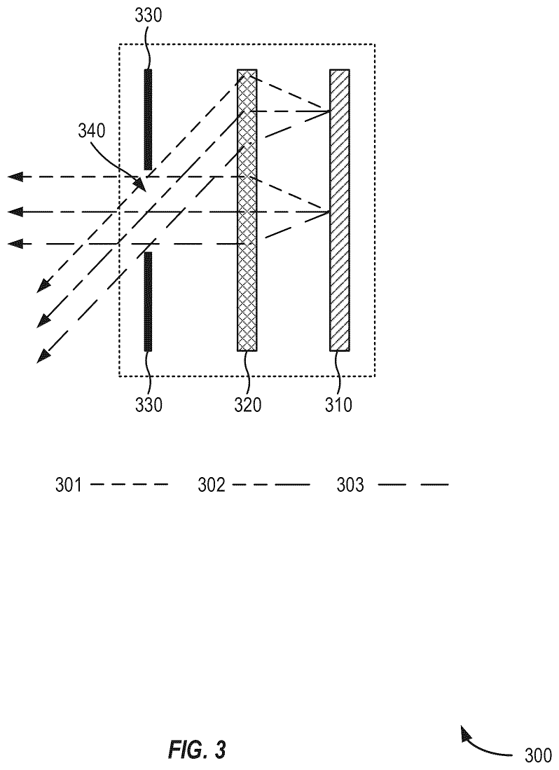

FIG. 3 is a schematic view of an optical device 300, according to one or more implementations. In one or more implementations, optical device 300 includes or is a component of an optical device lens 104. Optical device 300 includes a spatial light modulator 310, metasurface 320, and a surface 330 that defines an exit pupil 340. In one or more embodiments, optical device 300 is configured to operate on multichromatic light, for example multiple wavelengths or range of wavelengths of optical light, including the optical light 301, optical light 302, optical light 303, which may be three different colors of visible light in some examples. Although three different wavelengths (colors) of light are illustrated, in one or more embodiments different numbers of wavelengths (colors) of light may be used, for example two or four or more wavelengths (colors).

In one or more embodiments, spatial light modulator 310 may be or be referred to as a light engine. In one or more implementations, spatial light modulator 310 is a LED light engine that generates multichromatic light, for example multiple (e.g., two or more) wavelengths or range of wavelengths of optical light, including the optical light 301, optical light 302, optical light 303. In one or more embodiments, optical light 301, optical light 302, and optical light 303 are wavelengths associated with red, green, and blue light, respectively.

In one or more embodiments, metasurface 320 may be or be referred to as a metalens. In one or more examples, metasurface 320 is designed and configured to focus a set of wavelengths, or ranges of wavelengths, of optical light, including the optical light 301, optical light 302, and optical light 303 toward the exit pupil 340 of the optical device 300.

In one or more embodiments, metasurface 320 is or employs elements of a nanopillar metalens, a Huygens metalens, or a combination of these, for example as further discussed herein with reference to metasurface 220. In one or more embodiments, metasurface 320 has a first set of elements that can manipulate the amplitude, phase, and/or polarization of a light wave associated with optical light 301, a second set of elements that can manipulate the amplitude, phase, and/or polarization of a light wave associated with optical light 302, and a third set of elements that can manipulate the amplitude, phase, and/or polarization of a light wave associated with optical light 303. In some embodiments, some elements or sets of elements of the metasurface 320 can manipulate the amplitude, phase, and/or polarization of light waves associated with a combination of one or more of optical light 301, optical light 302, and/or optical light 303.

In one or more embodiments, the surface 330 that defines the exit pupil 340 for optical device 300 is an example of the surface 230 that defines the exit pupil 240 for optical device 200.

One or more advantages of one or more of the embodiments of optical device 300 include that optical device 300 may be relatively compact and full color, and provide for lower cost, increased design simplicity, manufacturing flexibility, and smaller form factor.

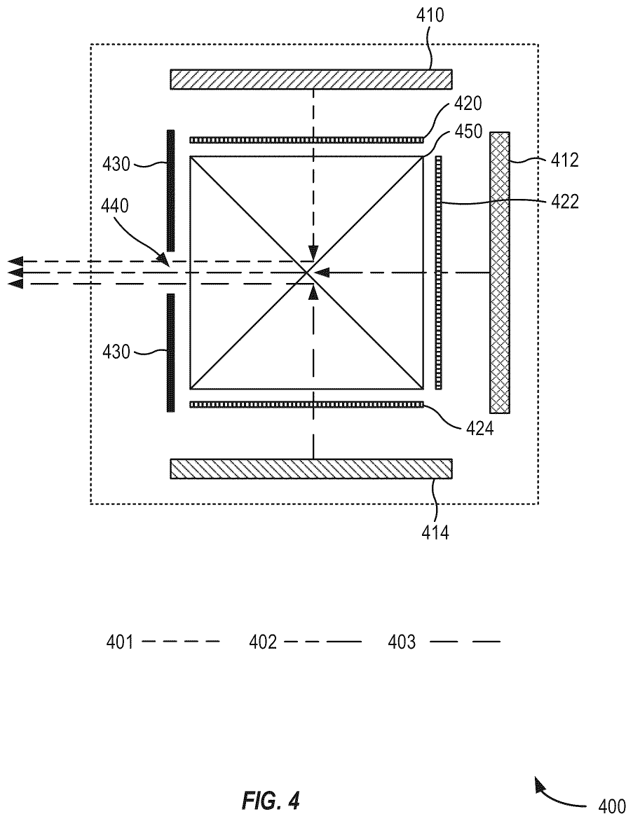

FIG. 4 is a schematic view of an optical device 400, according to one or more implementations. In one or more implementations, optical device 400 includes or is a component of an optical device lens 104. Optical device 400 includes a first spatial light modulator 410, a second spatial light modulator 412, a third spatial light modulator 414, a first metasurface 420, a second metasurface 422, a third metasurface 424, a surface 430 that defines an exit pupil 440, and an optical combiner 450. In one or more embodiments, optical device 400 is configured to operate on multichromatic light, for example multiple wavelengths or range of wavelengths of optical light, including the optical light 401, optical light 402, optical light 403, which may be examples of optical light 301, optical light 302, and/or optical light 303. Although three different wavelengths (colors) of light are illustrated, in one or more embodiments different numbers of wavelengths (colors) of light may be used, for example two or four or more wavelengths (colors).

In one or more embodiments, the first spatial light modulator 410, the second spatial light modulator 412, and the third spatial light modulator 414 may be or be referred to as a light engine. In one or more implementations, the first spatial light modulator 410, the second spatial light modulator 412, and the third spatial light modulator 414 each generate optical light 401, optical light 402, and optical light 403, respectively, each having different wavelengths or ranges of wavelengths. In one or more embodiments, optical light 401, optical light 402, optical light 403 are wavelengths associated with red, green, and blue light, respectively.

In one or more embodiments, the first metasurface 420, the second metasurface 422, and the third metasurface 424 may be or be referred to as metalenses. In one or more examples, the first metasurface 420 is designed and configured to focus a set of wavelengths, or ranges of wavelengths, of optical light, including the optical light 401, toward the exit pupil 440 of the optical device 400 via an optical combiner 450. The second metasurface 422 is designed and configured to focus a set of wavelengths, or ranges of wavelengths, of optical light, including the optical light 402, toward the exit pupil 440 of the optical device 400 via an optical combiner 450. The third metasurface 424 is designed and configured to focus a set of wavelengths, or ranges of wavelengths, of optical light, including the optical light 403, toward the exit pupil 440 of the optical device 400 via an optical combiner 450.

In one or more embodiments, one or more of the first metasurface 420, the second metasurface 422, and the third metasurface 424 are examples of a nanopillar metalens or a Huygens metalens, for example as further discussed herein with reference to metasurface 220.

In one or more embodiments, the optical combiner 450 is configured to direct the optical light 401 generated by the first spatial light modulator 410 and focused and directed by the first metasurface 420 toward the exit pupil 440, direct the optical light 402 generated by the second spatial light modulator 412 and focused and directed by the second metasurface 422 toward the exit pupil 440, and direct the optical light 404 generated by the third spatial light modulator 414 and focused and directed by the third metasurface 424 toward the exit pupil 440.

In one or more embodiments, the optical combiner 450 is a prism, or a combination of prisms, that combines the three-color channels of including the optical light 401, optical light 402, and optical light 403. In some examples, the optical combiner 450 is a trichroic prism or one or more dichroic prisms, for example an assembly of prisms or dichroic prisms. In one or more embodiments, optical combiner 450 includes or comprises one or more optical filters. In one or more embodiments, optical combiner 450 is a wavelength sensitive dielectric coated x-cube prism.

In one or more embodiments, the surface 430 that defines the exit pupil 440 for optical device 400 is an example of the surface 230 that defines the exit pupil 240 for optical device 200.

One or more advantages of one or more of the embodiments of optical device 400 include that the design of optical device 400 permits individual focusing of the three spatial light modulators (e.g., primary color micro-LED panels) with the additional flexibility of optimizing each metasurface (e.g., metalens) separately for the corresponding spatial light modulator.

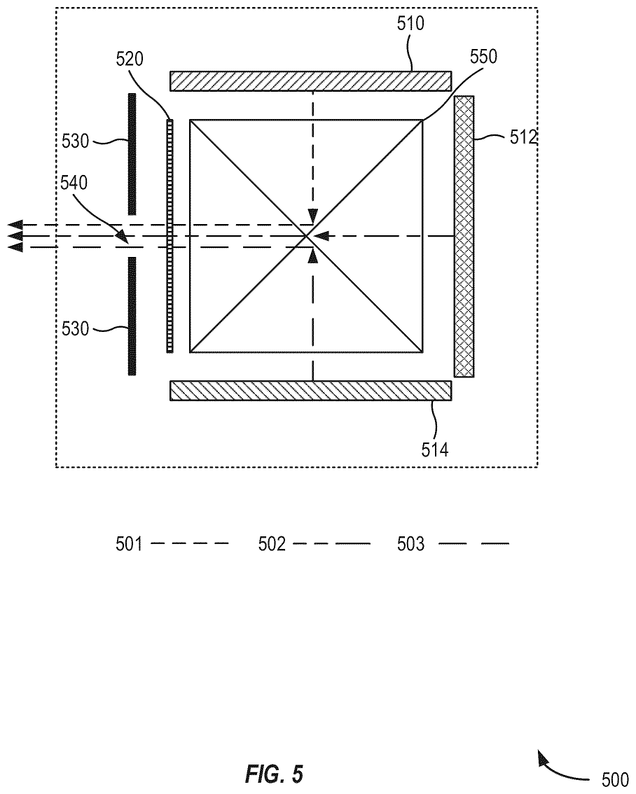

FIG. 5 is a schematic view of an optical device 500, according to one or more implementations. In one or more implementations, optical device 500 includes or is a component of an optical device lens 104. Optical device 500 includes a first spatial light modulator 510, a second spatial light modulator 512, a third spatial light modulator 514, a metasurface 520, a surface 530 that defines an exit pupil 540, and an optical combiner 550. In one or more embodiments, optical device 500 is configured to operate on multichromatic light, for example multiple wavelengths or range of wavelengths of optical light, including the optical light 501, optical light 502, and optical light 503, which may be examples of optical light 301, optical light 302, optical light 303, optical light 401, optical light 402, and/or optical light 403. Although three different wavelengths (colors) of light are illustrated, in one or more embodiments different numbers of wavelengths (colors) of light may be used, for example two or four or more wavelengths (colors).

In one or more embodiments, the first spatial light modulator 510, the second spatial light modulator 512, and the third spatial light modulator 514 are examples of the first spatial light modulator 410, the second spatial light modulator 412, and the third spatial light modulator 414, respectively.

In one or more embodiments, metasurface 520 may be an example of metasurface 320, and be designed and configured to focus a set of wavelengths, or ranges of wavelengths, of optical light, including the optical light 501, optical light 502, and optical light 503 toward the exit pupil 540 of the optical device 500 after the optical light 501, optical light 502, and optical light 503 have been combined using the optical combiner 550. In one In one or more embodiments, the optical combiner 550 may be an example of the optical combiner 450.

One or more advantages of one or more of the embodiments of optical device 500 include that the design of optical device 500 is relatively more compact in form-factor (e.g., more compact relative to the optical device 400).

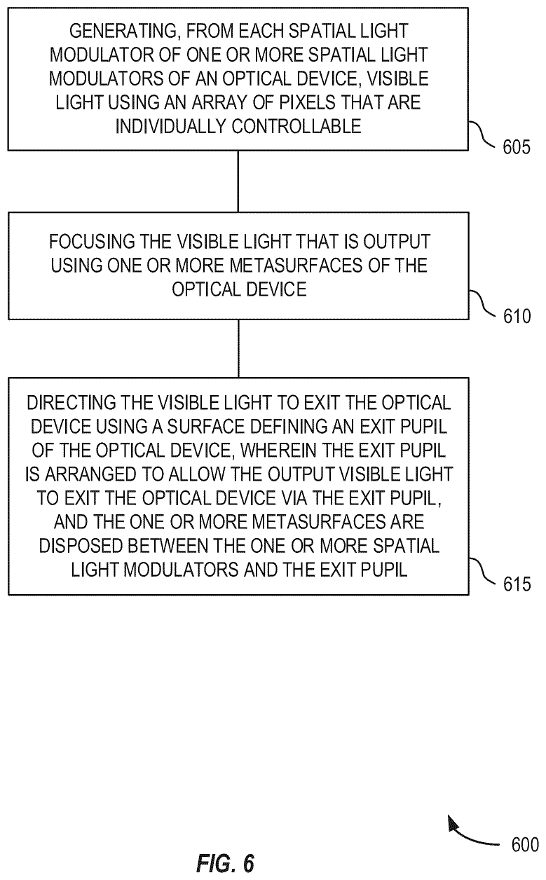

FIG. 6 is a flow diagram of a method 600 of generating an optical image, according to one or more implementations. In one or more embodiments, a system controller, or one or more components thereof, such as system controller 140, may perform one or more operations of the method 600. In one or more embodiments, one or more of optical device 200, optical device 300, optical device 400, optical device 500, or one or more components thereof, may perform one or more operations of the method 600.

Operation 605 of the method 600 includes generating, from each spatial light modulator of one or more spatial light modulators of an optical device, visible light using an array of pixels that are individually controllable. In one or more embodiments, the one or more spatial light modulators is a single spatial light modulator. In one or more embodiments, the one or more spatial light modulators is a single spatial light modulator that is controllable to output multichromatic light. In one or more embodiments, operation 605 may be performed by one or more of spatial light modulator 210, spatial light modulator 310, spatial light modulator 410, spatial light modulator 412, spatial light modulator 414, spatial light modulator 510, spatial light modulator 512, and/or spatial light modulator 514, or a combination of spatial light modulator 410, spatial light modulator 412, and spatial light modulator 414, or a combination of spatial light modulator 510, spatial light modulator 512, and spatial light modulator 514.

Operation 610 of the method 600 includes focusing the visible light that is output using one or more metasurfaces of the optical device. In one or more embodiments, the one or more metasurfaces is a single metasurface. In one or more embodiments, the one or more metasurfaces is a single metasurface to focus the multichromatic light. In one or more embodiments, operation 610 may be performed by one or more of metasurface 220, metasurface 320, metasurface 420, metasurface 422, metasurface 424, or metasurface 520, or a combination of metasurface 420, metasurface 422, metasurface 424.

Operation 615 of the method 600 includes directing the visible light to exit the optical device using a surface defining an exit pupil of the optical device, wherein the exit pupil is arranged to allow the output visible light to exit the optical device via the exit pupil, and the one or more metasurfaces are disposed between the one or more spatial light modulators and the exit pupil. In one or more embodiments, operation 615 may be performed by one or more of surface 230 (e.g., including an exit pupil 240), surface 330 (e.g., including an exit pupil 340), surface 430 (e.g., including an exit pupil 440), and/or surface 530 (e.g., including an exit pupil 540).

In one or more embodiments, the single spatial light modulator, the surface, and the single metasurface are substantially parallel.

In one or more embodiments, the method 600 further includes combining a first beam of visible light that is generated by a first spatial light modulator of the one or more spatial light modulators and a second beam of visible light that is generated by a second spatial light modulator of the one or more spatial light modulators, and directing the combination of the first beam and the second beam toward the exit pupil. In one or more embodiments, the one or more metasurfaces is a first metasurface associated with the first spatial light modulator, where the first beam of visible light traverses the first metasurface prior to being combined with the second beam of visible light, and a second metasurface associated with the second spatial light modulator, where the second beam of visible light traverses the second metasurface prior to being combined with the first beam of visible light.

In one or more embodiments, the method 600 further includes combining a first beam of visible light that is generated by a first spatial light modulator of the one or more spatial light modulators and a second beam of visible light that is generated by a second spatial light modulator of the one or more spatial light modulators, and directing the combination of the first beam and the second beam toward the exit pupil, where the one or more metasurfaces is a multichromatic metasurface, and the combination of the first beam and the second beam traverses the multichromatic metasurface prior to exiting the optical device via the exit pupil.

In one or more embodiments, combining beams of visible light (e.g., a first beam of visible light and a second beam of visible light) may be performed by an optical combiner 450 and/or an optical combiner 550.

One or more advantages of one or more of the embodiments of glasses 100, optical device 200, optical device 300, optical device 400, optical device 500, and/or method 600 include one or more of a reduced size and form factor (e.g., ultra-compact form factor) light engine and a relatively large (e.g., larger than current approaches using same or similar form factor light engines) numerical aperture for improved light collection efficiency, reduced overall device form-factor, reduced weight, and/or improve the power efficacy.

In one or more embodiments, the optical device provides a relatively larger NA, for example less than about 0.2, while providing a relatively larger filed o view, for example up to about 30 degrees, or up to about 45 degrees. In one or more embodiments, the optical device provides a relatively high image resolution, for example up to about 800 pixels by 640 pixels. In In one or more embodiments, the optical device provides a relatively high degree of telecentric uniformity, for example plus or minus five percent. In some embodiments, manufacturing of the optical device is more flexible than prior designs, is compatible with current semiconductor manufacturing processes, or both.

It is contemplated that various subject matter disclosed herein may be combined. As an example, one or more aspects, features, components, and/or properties of the glasses 100, optical device 200, optical device 300, optical device 400, optical device 500, and/or method 600 may be combined. Moreover, it is contemplated that various subject matter disclosed herein may include some or all of the aforementioned benefits.

While the foregoing is directed to embodiments of the present disclosure, other and further embodiments of the disclosure may be devised without departing from the basic scope thereof. The present disclosure also contemplates that one or more aspects of the embodiments described herein may be substituted in for one or more of the other aspects described. The scope of the disclosure is determined by the claims that follow.

What is claimed is:

1. An optical device, comprising:
one or more spatial light modulators, each spatial light modulator comprising an array of pixels that are individually controllable to output visible light;
a surface defining an exit pupil that is arranged to allow the visible light to exit the optical device via the exit pupil; and
one or more metasurfaces disposed between the one or more spatial light modulators and the exit pupil, the one or more metasurfaces to focus the visible light that is output by the one or more spatial light modulators.

2. The optical device of claim 1, wherein:
the one or more spatial light modulators comprise a single spatial light modulator; and
the one or more metasurfaces comprise a single metasurface.

3. The optical device of claim 2, wherein the single spatial light modulator, the surface, and the single metasurface are substantially parallel.

4. The optical device of claim 2, wherein the single spatial light modulator is controllable to output monochromatic light.

5. The optical device of claim 2, wherein the single spatial light modulator is controllable to output multichromatic light and the single metasurface is to focus the multichromatic light.

6. The optical device of claim 1, further comprising:
an optical combiner to combine a first beam of visible light that is generated by a first spatial light modulator of the one or more spatial light modulators and a second beam of visible light that is generated by a second spatial light modulator of the one or more spatial light modulators, and to direct the combination of the first beam and the second beam toward the exit pupil.

7. The optical device of claim 6, wherein the one or more metasurfaces comprise:
a first metasurface associated with the first spatial light modulator, wherein the first beam of visible light traverses the first metasurface prior to entering the optical combiner; and
a second metasurface associated with the second spatial light modulator, wherein the second beam of visible light traverses the second metasurface prior to entering the optical combiner.

8. The optical device of claim 6, wherein the one or more metasurfaces comprise a multichromatic metasurface disposed between the optical combiner and the surface defining the exit pupil, wherein the first beam and the second beam traverse the optical combiner before traversing the multichromatic metasurface.

9. The optical device of claim 1, wherein each metasurface of the one or more metasurfaces comprises a nanopillar metalens, a Huygens metalens, or a combination thereof.

10. The optical device of claim 1, wherein each spatial light modulator of the one or more spatial light modulators comprises a micro-light emitting diode array, a liquid crystal on silicon array, or a digital light processing array.

11. A wearable display, comprising:
a wearable support;
a first optical device retained by the wearable support and positioned to be viewed by a first eye of a user of the wearable display; and
a second optical device retained by the wearable support and positioned to be viewed by a second eye of the user,
wherein each optical device of the first optical device and the second optical device comprise:
one or more spatial light modulators, each spatial light modulator comprising an array of pixels that are individually controllable to output visible light;
a surface defining an exit pupil that is arranged to allow the visible light to exit the optical device via the exit pupil; and
one or more metasurfaces disposed between the one or more spatial light modulators and the surface defining the exit pupil, the one or more metasurfaces to focus the visible light that is output by the one or more spatial light modulators.

12. The wearable display of claim 11, wherein:
the one or more spatial light modulators comprise a single spatial light modulator;
the one or more metasurfaces comprise a single metasurface; and
the single spatial light modulator, the surface, and the single metasurface are substantially parallel.

13. The wearable display of claim 11, wherein:
the one or more spatial light modulators comprise a single spatial light modulator that is controllable to output multichromatic light; and
the one or more metasurfaces comprise a single metasurface to focus the multichromatic light.

14. The wearable display of claim 11, further comprising:
an optical combiner to combine a first beam of visible light that is generated by a first spatial light modulator of the one or more spatial light modulators and a second beam of visible light that is generated by a second spatial light modulator of the one or more spatial light modulators, and to direct the combination of the first beam and the second beam toward the exit pupil, wherein the one or more metasurfaces comprise:
a first metasurface associated with the first spatial light modulator, wherein the first beam of visible light traverses the first metasurface prior to entering the optical combiner; and
a second metasurface associated with the second spatial light modulator, wherein the second beam of visible light traverses the second metasurface prior to entering the optical combiner.

15. The wearable display of claim 11, further comprising:
an optical combiner to combine a first beam of visible light that is generated by a first spatial light modulator of the one or more spatial light modulators and a second beam of visible light that is generated by a second spatial light modulator of the one or more spatial light modulators, and to direct the combination of the first beam and the second beam toward the exit pupil, wherein the one or more metasurfaces comprise a multichromatic metasurface disposed between the optical combiner and the surface defining the exit pupil, wherein the first beam and the second beam traverse the optical combiner before traversing the multichromatic metasurface.

16. A method of generating an optical image, comprising:
generating, from each spatial light modulator of one or more spatial light modulators of an optical device, visible light using an array of pixels that are individually controllable;
focusing the visible light that is output using one or more metasurfaces of the optical device; and
directing the visible light to exit the optical device using a surface defining an exit pupil of the optical device, wherein the exit pupil is arranged to allow the output visible light to exit the optical device via the exit pupil, and the one or more metasurfaces are disposed between the one or more spatial light modulators and the exit pupil.

17. The method of claim 16, wherein:
the one or more spatial light modulators comprise a single spatial light modulator;
the one or more metasurfaces comprise a single metasurface; and
the single spatial light modulator, the surface, and the single metasurface are substantially parallel.

18. The method of claim 16, wherein:
the one or more spatial light modulators comprise a single spatial light modulator that is controllable to output multichromatic light; and
the one or more metasurfaces comprise a single metasurface to focus the multichromatic light.

19. The method of claim 16, further comprising:
combining a first beam of visible light that is generated by a first spatial light modulator of the one or more spatial light modulators and a second beam of visible light that is generated by a second spatial light modulator of the one or more spatial light modulators;
directing the combination of the first beam and the second beam toward the exit pupil, wherein the one or more metasurfaces comprises:
a first metasurface associated with the first spatial light modulator, wherein the first beam of visible light traverses the first metasurface prior to being combined with the second beam of visible light, and
a second metasurface associated with the second spatial light modulator, wherein the second beam of visible light traverses the second metasurface prior to being combined with the first beam of visible light.

20. The method of claim 16, further comprising:
combining a first beam of visible light that is generated by a first spatial light modulator of the one or more spatial light modulators and a second beam of visible light that is generated by a second spatial light modulator of the one or more spatial light modulators;
directing the combination of the first beam and the second beam toward the exit pupil, wherein the one or more metasurfaces comprises a multichromatic metasurface, and wherein the combination of the first beam and the second beam traverses the multichromatic metasurface prior to exiting the optical device via the exit pupil.
